(19) United States
(12) Patent Application Publication
(10) Pub. No.: US 2010/0055226 A1
(43) Pub. Date: Mar. 4, 2010

(54) HOT OR COLD RUNNER MANIFOLD

(76) Inventor: Herbert Gunther, Allendorf (DE)

Correspondence Address: CLARK & BRODY, 1090 VERMONT AVENUE, NW, SUITE 250, WASHINGTON, DC, 20005, US

(21) Appl. No.: 12/553,302

(22) Filed: Sep. 3, 2009

(30) Foreign Application Priority Data
Sep. 4, 2008 (DE) 10 2008 045 701.9

(51) Int. Cl. B29C 45/27

(52) U.S. Cl. 425/547

(57) ABSTRACT

The invention relates to a manifold 20 for a hot or cold runner 10 and fitted with a manifold plate 201 which comprises a main feed duct 24 for a flowable feed material and further contains a manifold duct system 40 having manifold ducts 41, 42, 43, said system communicating flow-wise through nozzle feed ducts 26 with flow ducts 32 of injection molding nozzles 30 connected to said manifold plate 201. Each manifold duct 42, 42, 43 communicates flow-wise with the main feed duct 24 and/or with at least one manifold feed duct 27, 271, 272, each manifold duct 411 42, 43 issuing into at least one manifold feed duct 27, 271, 272 and/or into at least one nozzle feed duct 26 and each manifold feed duct 27, 271, 272 issuing into a further manifold duct 41, 42, 43 and each nozzle feed duct 20 into the flow duct 32 of each associated injection molding nozzle 30. The manifold ducts 41, 42, 43, the manifold feed ducts 27, 271, 272 and/or the nozzle feed ducts 26 are dimensioned in a way to balance the manifold duct system. The nozzle feed ducts 26 may be arrayed in an n×m matrix, where n=m or n≠m and n≧3. The manifold ducts 41, 42, 43 may be situated in one plane and be horizontal. The manifold feed ducts 27, 271, 272, the nozzle feed ducts 26 and the main feed duct 24 may be vertical. The main feed duct 24 is mounted in a way that none of the nozzle feed ducts is situated directly below the main feed duct 24.

The present invention relates to a manifold for a hot or cold runner defined in the preamble of claim 1 and to a hot or cold runner defined in claim 23.

Manifolds are widely known. They are used in injection molds to feed a flowable material at a predetermined temperature and high pressure to a separable mold block (molding nest). Typically one or more injection molding nozzles are connected to the manifold or to the manifold plate and terminate in a melt duct in the associated molding nest. The manifold is fitted with manifold ducts communicating flow-wise through a main feed duct with a mold nozzle and through nozzle discharge apertures with the injection molding nozzles.

Many applications require simultaneously gating several times and simultaneously separate cavities or complex parts being molded. Accordingly the nozzles are mounted in defined mutual configurations on the manifold. It is important in this respect that all nozzle feed ducts receive simultaneously, accurately and at the same pressure the same quantity of flowable material in order that all parts being molded be made uniformly. In turn it is important that the system be balanced—in quantity and quality—when manufacturing the manifold block.

In this respect “naturally balanced” manifold systems are known. In such designs all manifold ducts are equally long and their diameters are the same, as a result of which all nozzle discharge apertures are fed with the same quantity/rate of material. On the other hand such designs incur the drawback only even-numbered, symmetrical or specific star-shaped nozzle configurations are possible. Also the nozzles situated underneath the manifold requiring a given space, their number shall be limited. Star-shaped configurations comprising many nozzles therefore subtend a large radius. The space at the center of the star is comparatively large and unavailable.

More complex and/or relatively more concentrated nozzle arrays are known, which comprise additional (accessory) manifold plates that in turn are naturally balanced and are fed from a central main manifold plate. Such a design however incurs the drawback that the hot or cold runners require significant space. Also all planes of the manifold block constituted by the manifold plates must be heated to assure maintaining a uniform melt temperature as far as the nozzle. This feature is complex and hence costly.

It is also known to balance a manifold system by matching the duct diameters to the duct lengths. Operability of such a numerically balanced system however strongly depends on the special operating temperature and material-specific properties of the operational melt. The applicability of such manifolds is restricted, especially when involving complex nozzle arrays.

Accordingly it is the objective of the present invention to overcome the above and other drawbacks of the state of the art and to create an improved hot or cold runner manifold which is manufactured in simple and economic manner and makes possible continuously reliable operation. In particular the present invention relates to a manifold admitting complex, multiple nozzle arrays but nevertheless still being compact. The individual nozzles shall be tightly packed using the full manifold surface.

The main features of the present invention are defined in claim 1 and in claim 25. Embodiment modes are defined in claims 2 through 24.

With respect to a hot or cold runner manifold comprising with a manifold plate fitted with both a flowable feed-material main duct and with a system of manifold ducts, said system communicating flow-wise by means of nozzle feed ducts with the flow ducts of injection molding nozzles connected to the manifold plate, the present invention provides that manifold feed ducts be constituted within the manifold plate, each manifold duct communicating flow-wise with the main feed duct or a manifold feed duct, each manifold duct issuing into at least one manifold feed duct and/or at least one nozzle feed duct, and each manifold feed duct issuing into a further manifold duct and each nozzle feed duct issuing into the flow duct of the associated injection molding nozzle, and that the manifold duct, the manifold feed ducts and/or the nozzle feed ducts are dimensioned in a way to balance the manifold duct system.

The manifold or manifold plate design of the present invention makes it possible to position a complex array of injection molding nozzles within a comparatively compact space, almost the entire manifold surface being available for use. The manifold ducts issuing from the main feed duct and from the manifold ducts rapidly and reliably distribute the injection molding material to be processed to all nozzle feed ducts, the entire system being balanced by design. The simply and clearly structured manifold duct system moreover allows rapid and economic manufacture of the manifold respectively the manifold plate.

In a particular embodiment mode of the present invention, the nozzle feed ducts are arrayed in an n×m matrix, where n=m or n≠m. In particular n≧3. By means of such a hot or cold runner of the invention, illustratively nine nozzles and hence nine mold nests may be operated simultaneously, the nozzles being distributed as a 3×3 array over the manifold surface. Preferably the nozzles respectively mold nests adjacent in one direction shall be mutually equidistant Moreover the nozzles respectively mold nests may be packed very tightly against each other, the limiting constraint being the space needed by the nozzle. As a result, the nest spacings may be minimized. Unused spaces are substantially eliminated.

The present invention offers a further advantage, namely that the hot runners fitted with such a manifold exhibit a rectangular to fully square base area and therefore may be grouped very simply into larger assemblies. Again a regular three-dimensional configuration of several hot runners is easily attained. Illustratively spherical structures may be easily and reliably made in this manner, in particular when, on geometric grounds, a large number of nozzles corresponding to a multiple of nine should be required.

Illustratively all manifold ducts of a manifold of the invention may be constituted in one plane. This feature offers the advantage that the manifold plate can be made to be very planar.

However the manifold duct system also may extend across at least two planes, manifold ducts being formed in each plane and manifold ducts of a first plane communicating through manifold feed ducts with the manifold ducts of another plane. This feature makes it possible to naturally balance the manifold ducts of individual planes even when the number and configuration of the nozzle feed ducts to be fed as a whole require balancing the system numerically. Accordingly the dependency on an exclusively numerically balanced system is considerably reduced.

On the whole, accordingly, the manifold duct system besides the main feed duct may contain various horizontal and vertical ducts. The melt is rapidly and reliably distributed within the manifold, the planes receiving the manifold ducts communicating through the feed ducts.

The manifold feed ducts and the and the nozzle feed ducts advantageously run vertically and may run across several planes, the individual planes communicating with each other. Also the manifold feed ducts may feed the processing material to the manifold ducts of several planes. The nozzle feed apertures may connect the manifold ducts of an upper or a lower plane to the flow duct of an injection molding nozzle.

The manifold ducts comprise main manifold ducts, lower manifold ducts and terminal-manifold ducts, and preferably shall be horizontal and communicating flow-wise through the vertical manifold feed ducts.

Appropriately, moreover, the main feed duct is configured in a way that none of the nozzle feed ducts is directly positioned underneath it. Where this condition is met, all nozzle feed ducts may be fed independently from the main feed duct by one or more manifold ducts. Accordingly the system may be balanced, namely the dimensions of the manifold ducts are matched relative to the diameter and length of the manifold ducts. Preferably the main feed duct is configured vertically though it also might be constituted by a horizontal and a vertical segment.

As regards embodiment variations fitted with needle valve nozzles, it is especially advantageous to configure the main feed duct outside the manifold's center. In this configuration the valve needles may pass through the nozzle feed ducts absent any mutual hampering of material feed and valve needle operation.

It is clear that the presence of several planes is used to symmetrically split up the material to be distributed. In the process the material is guided toward different deviation points. These deviation points are constituted by the manifold feed ducts. If the number of deviation points doubles with each change of plane, system balancing is advantageously facilitated.

When the spacings between the nozzle feed ducts and the manifold feed ducts feeding manifold ducts issuing into them are always equal, such balancing is enhanced further. In such a case the corresponding manifold ducts lengths are the same and it is enough that the manifold duct diameters be matched accordingly.

With respect to the most compact possible design of the hot or cold runners, advantageously the manifold ducts of the manifold duct system are configured in a way that no manifold duct of one plane shall run above and/or below the manifold duct of another plane. In this manner the planes may be configured in a way that they even partly lie in each other. Because the manifold ducts of the planes do not cross, the deflection of the said feed material may take place unhampered even in this case. Also the manifold plate may be made extremely flat.

In all the above or further advantageous embodiment modes, the manifold may be constituted by three plates, namely a base plate, an intermediate plate, and a cover plate. This feature simplifies manifold manufacture and makes it economical.

In one advantageous feature, each manifold duct is bounded by two of those plates. As a result the manifold ducts may be configured in two or more planes without the need for additional manifold plates. In this manner one may create manifold ducts bounded in an upper plane by the cover and the intermediate plates and on the other hand manifold ducts bounded in a lower plane by the base and the intermediate plates. In this embodiment the manifold ducts may be structured in a way to accommodate a corresponding recess fitted into the lower or upper surface of the intermediate plate and tightly sealed by a smooth surface of the cover plate respectively base plate as if by a cover. Conceivably the intermediate plate also may be flat at one or both surfaces and does per se cover corresponding recesses in the cover plate respectively base plate. Accordingly the manifold as a whole, and especially the plates bounding the recesses, may be made extremely flat and compact.

The above feature also allows very simple insertion of the manifold duct system into the manifold's plates. It suffices to fashion the manifold feed ducts and the nozzle feed ducts as boreholes passing through the intermediate plate respectively the base plate. The manifold ducts can be inserted without problems at the surface of the plates in the form of corresponding connecting conduits between the various feed ducts, for instance by milling, erosion or etching.

Obviously the manifold ducts also may be inserted as horizontal connecting boreholes into the plates. To limit the manifold ducts, the connecting boreholes may be blocked in the hookup, for instance using stoppers or other seals.

Appropriately the manifold feed ducts are constituted in such manner in the intermediate plate that they connect the manifold duct bounded by the base plate and the intermediate plate with the manifold ducts bounded by the cover plate and the intermediate plate. Appropriately again, the nozzle feed ducts are constituted in the base and/or intermediate plates and the main feed ducts are constituted in the cover plate and/or intermediate plate.

Appropriately again, the base plate, the intermediate plate and the cover plate may be linked to each other in mechanically interlocking or frictional manner. Illustratively the plates may be joined to each other by screw means, soldering or welding.

In one advantageous embodiment, the main feed duct issues into one or more primary manifold feed ducts and/or each primary manifold duct issues into one or more manifold feed ducts and/or each secondary manifold feed duct issues into one or more terminal manifold ducts and/or each terminal manifold duct issues into one or more nozzle feed ducts.

In an especially significant embodiment variant, the main feed duct issues into a V-shaped manifold duct constituted by two main manifold ducts. The V-shaped manifold duct is situated in a first plane and issues into two primary manifold feed ducts. Each primary manifold feed duct issues each time into a lower manifold duct, the lower manifold ducts being configured in a second plane and each issuing into two secondary manifold feed ducts. Each lower manifold duct contains one secondary manifold feed duct situated proximally to the main feed duct, the other secondary manifold feed duct being situated distally from the main feed duct. The primary manifold feed ducts situated distally to the main feed duct feed each four terminal manifold ducts. The secondary manifold ducts situated proximally to the main feed duct each feed three terminal manifold ducts. Again the terminal manifold ducts are configured in the first plane and issue into the nozzle feed ducts feeding the injection molding material to the particular nozzles. This embodiment mode offers an especially advantageous balanced manifold duct system in which the nine nozzles are arrayed in a symmetrical 3×3 matrix.

The first plane of such a manifold duct system illustratively may be constituted between the cover plate and the intermediate plate, the second plane may be constituted between the intermediate and the base plates. However other configurations are also feasible.

The manifold also may be a lower manifold. This feature illustratively is advantageous when several hot runners are grouped in a way that they jointly gate one component. In this manner the synchronization of the individual lower manifolds is made significantly easier and may be implemented by an overriding main manifold connected to molding machine nozzle.

In another embodiment mode, the manifold also may be a main manifold. In this design the nozzle feed apertures issue in the main feed apertures of further lower manifolds.

Advantageously too, the manifold might comprise at least two intermediate plates. In particular such an embodiment mode allows complex configurations for which for instance n>>m or n<<m.

As regards an advantageous hot or cold runner of the invention fitted with a manifold of the invention, each injection molding nozzle may comprise a material feed pipe, a heater and a muff. Advantageously as regards mold compactness, the heater hookups shall be configured in the manifold's base plate. Advantageously again, the material feed pipe of the injection molding nozzle can be directly affixed to the base plate. Such a feature precludes the material feed pipe from slipping relative to the nozzle feed ducts, as might the case due to the different expansions of the manifold and the injection molding nozzle. Hence the present invention offers the further advantage that the nozzle feed ducts issue in axially aligned manner into the flow duct constituted in the feed pipe of the particular injection molding nozzle.

Further features, particulars and advantages of the present invention are defined in the claims and discussed in the following description of illustrative embodiments in relation to the appended drawings.

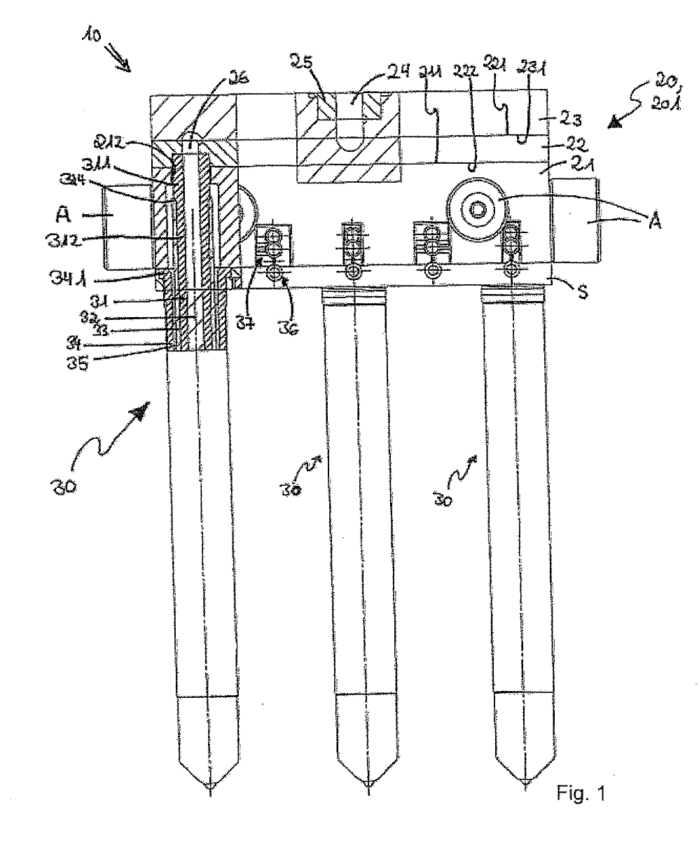

FIG. 1 schematically shows a hot or cold runner with a manifold,

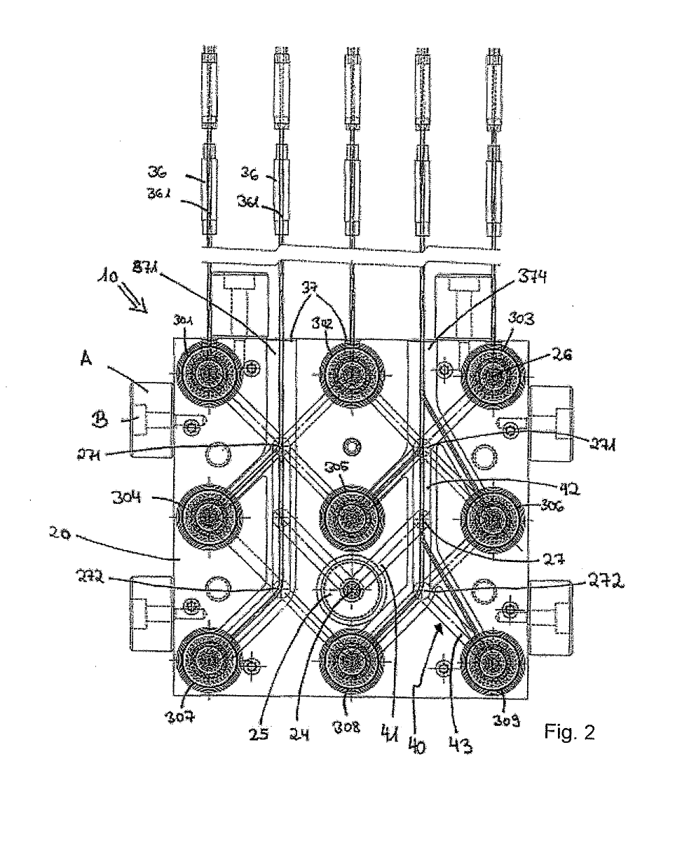

FIG. 2 is a schematic topview of FIG. 1,

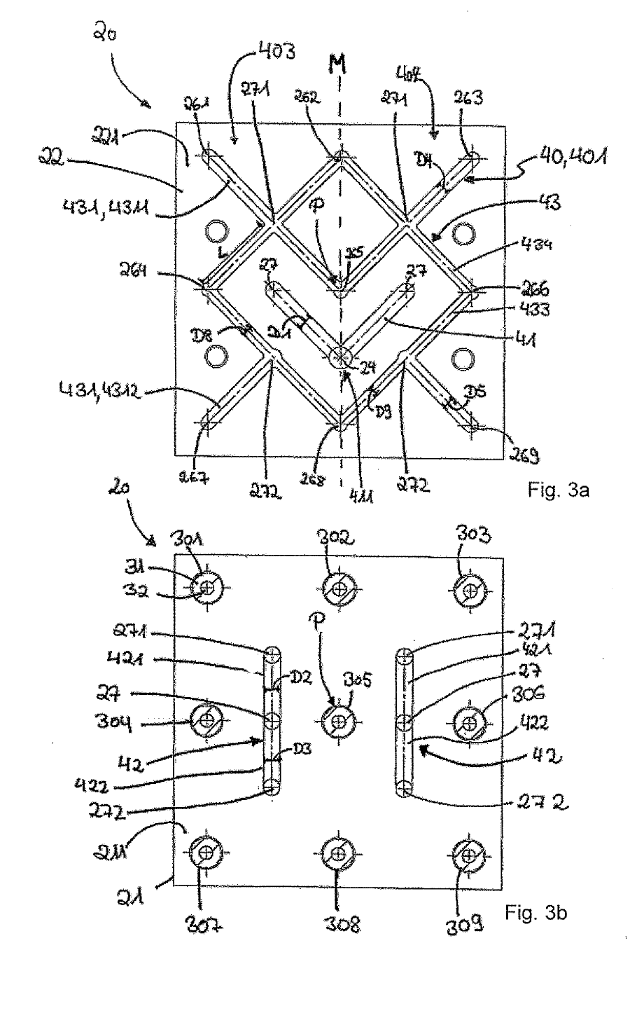

FIG. 3a is a cross-section of the manifold of FIGS. 1 and 2 in the region between the cover plate and the intermediate plate with nine nozzle feed ducts, and

FIG. 3b is a cross-section of the manifold of FIGS. 1 and 2 in the region between the base plate and the intermediate plate.

FIG. 1 shows a hot or cold runner 10 with a manifold 20 and several injection molding nozzles 30.

The manifold 20 comprises a manifold plate 201 constituted by a base plate 21, an intermediate plate 22 and a cover plate 23. A main feed duct 24 of diameter D1 is fitted into the cover plate 23. A hookup 25 for the omitted injection mold feed nozzle is configured in the zone of the main feed duct 24.

Each injection molding nozzle 30 is constituted by a material feed pipe 31 subtending a flow duct 32. The flow duct communicates flow-wise and is axially aligned with a nozzle feed duct 26 constituted in the intermediate plate 22 of the manifold 20.

The material feed pipe 31 comprises an upper end 311, a central segment 312 and a lower segment 313. The material feed pipe 31 is affixable by its upper end 311 into a recess 212 in the manifold's base plate 21, for instance being screwed or pressed into it. If more compactness is required, the recess 212 also may be extended into the intermediate plate 22 as shown in the in this embodiment mode. The material feed pipe 31 is enclosed by a heater 33 in the middle and lower segment 312, 313.

The heater 33 illustratively may be slipped over the material feed pipe 31. Said heater rests on an offset 314 constituted between the upper end 311 and the central segment 312 of said pipe. Connectors 36 connect each heater 33 to an omitted regulator. Channels 37 are provided in the base plate 21 to receive the connectors 35.

The heater 33 and the material feed pipe 31 are enclosed by a muff 34 in the region of the lower segment 313. At its manifold-facing side, the muff 34 is fitted with a flange 341 by means of which it rests on the base plate 21 of the manifold 20. An insulating air gap 35 is subtended between the heater 33 and the muff 34. The muff 34 is affixed by a securing plate S to the manifold 20. In an especially advantageous embodiment of the present invention, said securing plate is of low thermal conductivity, for instance being titanium. Accordingly the plate S serves not only for affixation, but also to thermally insulate the manifold 20.

FIG. 1 furthermore shows spacers A are configured at the small sides of the base plate 21. These spacers allow uniformly configuring several manifolds 20 directly next to each other. As a result, the injection molding nozzles 30 of several hot or cold runners 10 can be aggregated into substantially large groups. These spacers A are especially advantageous when the injection molding nozzles 30 of a hot or cold runner duct 10 are configured as an n×m matrix. Said spacers assure that the outer injection molding nozzles 30 of neighboring hot or cold runners are mutually separated by the same spacing as are a hot or cold runner's injection molding nozzles 30 between themselves.

FIG. 2 shows that nine injection molding nozzles 30, 301, 302, 303, 304, 305, 306, 307, 308, 309, are configured in a symmetric 3×3 matrix on the manifold 20 of the hot or cold runner 10.

A manifold duct system 40 runs in the manifold 20 and feeds the injection molding nozzles 30, 301, 302, 303, 304, 305, 306, 307, 308, 309 with melt. Moreover several hookup channels 371, 372, 373, 374 which pass the conductors 361 of the electrical connections 36 for the heaters 33 of the injection molding nozzles 30, 301, 302, 303, 304, 305, 306, 307, 308, 309 are constituted in the manifold 20 and constitute a hookup channel system 37. Spacers A are affixed by fastener elements B such as screws to the small sides of the manifold 20.

To feed the front three injection molding nozzles 301, 302, 303, the hookup channel system 37 is fitted with relatively short connecting ducts 372 directly feeding the particular nozzles. The middle three injection molding nozzles 304, 305, 306 and the rear three injection molding nozzles 307, 308, 309 are fed through two main hookup channels 371, 374 to which are branched further hookup side channels 373. The hookup main channel 371 feeds two consecutive nozzles 304, 307 and the other hookup main channel 371 feeds four consecutively situated nozzles 305, 306, 308, 309. The figures show that all hookups 36 are guided on a common side of the manifold 20 into the hookup channel system 37. This feature is especially advantageous when several manifolds 20 are arrayed next to each other.

The manifold channel system 40 consists of different manifold ducts 41, 42, 43, the main feed duct 24, several manifold feed ducts 27, 271, 272 and the nozzle feed ducts 41. The main feed channel 24 issues into two V-shaped main manifold ducts 41. These issue into two primary manifold feed ducts 27 guiding the melt in two lower manifold ducts 42. These lower manifold ducts 42 in turn issue into a manifold feed duct 271 distant from the main feed duct and into a manifold feed duct 272 near said main feed duct. The distant (distal) manifold feed ducts 271 guide the melt to each of four nozzle feed ducts 43. All the terminal manifold ducts 43 issue each into a nozzle feed duct 26 communicating flow-wise with the flow duct 32 of an injection molding nozzle 30. FIGS. 3 and 4 show a detailed view of the manifold duct system 40.

As shown in FIGS. 3a and 3b, the manifold duct system 40 consists of an upper and a lower plane 401 and 402 respectively. The manifold ducts 41, 43—which are configured in the upper plane—are subtended by recesses in the top side of the intermediate plate 22. The manifold ducts 42—which are configured in the lower plane 402—are subtended by recesses in the top side 211 of the lower plate 21.

FIG. 3 shows that the main feed duct 24 issues into the tip 411 of a V-shaped manifold duct constituted by two main manifold ducts 41. These main manifold ducts 41 are situated in the upper plane 401 and each issue into a primary manifold feed duct 27. The manifold duct system 40 as a result is split into two mutually symmetrical main arms 403, 404, a right main arm 403 and a left main arm 404. In this configuration the main feed duct 24 is situated on the axis of symmetry M of the manifold 20 between the two arms 403, 404. Said main feed duct is situated on the same lines as the nozzle feed ducts 262, 265, 268 though outside the center P of the manifold 20 which is situated exactly above the central nozzle feed duct 265. Accordingly all nozzle feed ducts 26 are configured in a way allowing passing valve needles for the injection molding nozzles through them.

The diameters D1 of the two main manifold ducts 41 are the same. Again, the manifold feed ducts 27 are the same distance from the main feed duct 24. Accordingly both main arms 403, 404 of the manifold duct system 40 receive the same rate of melt in the same state and at the same pressure.

Each primary manifold feed duct 27 connects a main manifold duct 41 situated in the upper plane 401 to a lower manifold duct 42 situated in the lower plane 402 and shown in FIG. 3b. The primary manifold feed duct 27 issues precisely into the middle of the lower manifold duct 42 which thereby is divided into two segments 421, 422 of equal lengths. The segment 421 leads to a secondary manifold feed duct 271 situated distally from the main feed duct 24. The other segment 422 leads to a secondary manifold feed duct 24 situated proximally to the main feed duct 24. The secondary manifold feed ducts 271, 272 return the melt into the upper plane 401 of the manifold duct system 40. The lower manifold ducts being of the same length and having the same diameter, the lower plane 402 of the manifold duct also is naturally balanced.

FIG. 3a shows that the distal, secondary manifold feed ducts 271 each feed four terminal manifold ducts 433 issuing into nozzle feed ducts 26. The proximal secondary manifold ducts 272 each feed three of such terminal manifold ducts 43.

Again FIG. 3a shows that the nozzle feed ducts 261, 263, 267, 269 situated in the matrix corners are fed each from a single terminal manifold duct 431. The nozzle feed ducts 262, 264, 266, 268 situated at the middles of the sides and the central nozzle feed duct 265 on the other hand are each fed from two terminal manifold ducts 432, 433, 434, 435, 436. Therefore, in the first place, the nozzle feed ducts 26 differ from each other by being fed either by one or by two manifold ducts 43.

Another feature by which the nozzle feed ducts 26 are different is that they are being fed either from a quadruply distributing manifold feed duct 271 or by a triply distributing manifold feed duct 272. The terminal manifold ducts 4311, 436, 435 feeding the nozzle feed ducts 261, 262, 263, 265 in turn are fed from a quadruple manifold feed duct 271. The terminal feed ducts 4312, 432 feeding the nozzle feed ducts 267, 268, 269 in turn are fed by a triple manifold feed duct 272. The nozzle feed ducts 264, 266 each are fed from a terminal manifold duct 433 which in turn is fed by a triple manifold feed duct 272 and from a terminal manifold duct 434 which in turn is fed from a quadruple manifold feed duct 271.

All terminal manifold ducts 43, 431, 432, 433, 434, 435, 436 are the same length L. The diameters D4, D5, D6, D7, D8, D9 of the manifold ducts 43, 431, 432, 433, 434, 435, 436 however are adjusted in a manner that all nozzle feed ducts 26, 261, 262, 263, 264, 265, 266, 267, 268, 269 are simultaneously fed with melt. In particular the diameters D4, D5 of the individually feeding terminal manifold ducts 432, 433, 434, 435, 436 are larger than the diameters D6, D7, D8, D9 of the terminal manifold ducts 432, 433, 434, 435, 436 that pairwise feed a nozzle feed duct 26, 262, 264, 265, 266, 268.

Also, in order to balance the system, the diameters of the terminal manifold ducts 4311, 436, 435, 434 serviced by the quadruply feeding manifold feed ducts 271 may be matched to the diameters of the terminal manifold ducts 4321, 433, 432 serviced by the triply feeding manifold feed ducts 272.

FIGS. 3a and 3b furthermore show that the nozzle feed ducts 26, 261 262, 263, 264, 265, 267, 268, 269 are configured in the intermediate plate 22 of the injection molding nozzles 30, 301, 302, 303, 304, 305, 306, 307, 308, 309 in a way hat they are in alignment above the material feed pipes 32 in a manner to directly introduce the melt into the melt ducts 32 of the injection molding nozzles 30, 301, 302, 303, 304, 305, 306, 307, 308, 309.

In sum, the manifold of the invention feeds simultaneously melt in the same state, at the same pressure and in equal amounts to all nine injection molding nozzles 30, 301, 302, 303, 304, 305, 306, 307, 308, 309 arrayed as a 3×3 matrix. In spite of an odd number of nozzles 30 and their most compact configuration, the manifold is balanced.

The present invention is not restricted to one of the above discussed embodiment modes, on the contrary it may be modified in many ways.

Illustratively the manifold ducts 41, 42, 43 may be constituted in the cover plate 23, in the base plate 21 or in the intermediate plate 22.

All ducts 41, 42, 43, 43, 24, 27, 26 may be made by drilling, milling, etching or erosion.

The main manifold ducts 41, the lower manifold ducts 42 and the terminal manifold ducts 43 may always be designed to be in the upper plane 401 and/or the lower plane 402. Said ducts may run horizontally, vertically and/or obliquely within and/or between the planes 401, 402. Again, the main feed duct 24, the manifold feed ducts 27, 271, 272 and/or the nozzle feed ducts 26 may run horizontally, vertically and/or obliquely within and/or between the planes 401, 402.

The spacings between neighboring nozzles 30 may vary. Such a design might be advantageous for instance when several hot runners are configured into a larger group.

When the spacings between the nozzles 30 vary, the lengths of the terminal manifold ducts 43, 431, 432, 433, 434, 435, 436 may be of different lengths. This feature may be advantageous for balancing when said terminal manifold ducts 43, 431, 432, 433, 434, 435, 436 exhibit the same diameter D4, D5, D6, D7, D8, D9.

The manifold duct system also may comprise more than two planes. In that case the manifold ducts 41, 42, 43 and/or the feed ducts 24, 26, 27, 271, 272 running vertically and/or obliquely between the planes also may pass through one or more of these planes.

When the nozzle feed apertures 265 are not closed by valve needles, the main feed duct 24 may also may be centrally configured in a first plane 401 above the central nozzle feed aperture 265 and it may feed two main manifold ducts 41. Conceivably, the lower manifold ducts 42 and the terminal manifold ducts 43 are situated in a common second plane 402. The main manifold ducts are configured in V-shape and run diagonally in a manner between the first and second planes 401, 402 that they each directly connect the main feed duct 24 with a lower manifold duct 42. The lower manifold ducts 42 in this instance issue illustratively into the middle of the lower manifold ducts 42. The lower manifold ducts 42 again issue into a total of four manifold feed ducts 271, 272. Said feed ducts 271, 272 in turn can feed several, for instance three or four terminal manifold ducts 43 which are configured in the same plane as the lower manifold ducts 42 or in another plane.

Conceivably again the main feed duct 24 may issue into a single, linear main manifold duct 41, for instance centrally into it. Said duct 41 again terminates at two primary manifold feed ducts 27. These two primary manifold feed ducts 27 guide the melt into a lower manifold duct 42 which is angled and branching at its end. The primary and distal secondary manifold feed ducts 271, 272 are constituted again at the ends said lower manifold ducts. Said ducts 271, 272 each feed four terminal manifold ducts 43. In this way the central nozzle feed duct 265 can be fed by means of four terminal manifold ducts 435. As a result, the plane containing the terminal manifold ducts 435 can be numerically balanced in especially simple manner.

Again, the main and the lower manifold ducts 41, 42 may be situated in one plane jointly with the terminal manifold ducts 43, 431, 432, 433, 434, 435, 436. Several main manifold ducts 41 may be provided which illustratively issue directly into the lower manifold apertures 271, 272. Again, the main manifold duct(s) 41 may issue into curving lower manifold ducts 42. The main manifold ducts 41 and the terminal manifold ducts 43, 431, 432, 444, 434, 435, 436 also may be curved. Such features are especially advantageous when the ducts have been made by milling the top and/or lower surface of one of the manifold plates.

Also, the segments 4321, 422 of the lower manifold ducts 42 may be fitted with different diameters D2, D3. This feature is advantageous where compensation is needed for the secondary manifold feed ducts 271, 272 feeding many terminal manifold ducts 43 in different manner(s).

The manifold 20 can be heated. Illustratively a tubular heating element affixed by welding/soldering or force-fitted into a groove may be used, or a thick-film heating element which is mounted directly or affixed as a separate component.

The connectors 36 may be guided into the hookup duct system 36 on different sides of the manifold.

The injection molding nozzles 30 may be both hot or cold runner nozzles. Moreover the injection molding nozzles may be in the form of needle valve nozzles, open sprue nozzles or tip-fitted nozzles.

Also the flange 341 may be fitted with fastener elements to affix the muff 34. Illustratively boreholes receiving screws or other fastener means may be provided.

All features and advantages, inclusive design details, spatial configurations and procedural steps implicit in or explicit from the claims, the specifications and the drawings, may be viewed as inventive whether per se or in arbitrary combinations.

As regards a manifold 20 for a hot or cold runner 10 and fitted with a manifold plate 201 comprising a main feed duct 24 for a flowable material and receiving a manifold duct system 40 with manifold ducts 41, 43, 43 communicating flow-wise by means of nozzle feed ducts 26 with the flow ducts 32, It should be borne in mind that manifold feed ducts 27, 271, 272 are constituted inside the manifold plate 201. Each manifold duct 41, 42, 43 communicates flow-wise with the main feed duct 24 and/or at least one manifold feed duct 27, 271, 272, each manifold duct 41 42, 43 issuing into at least one manifold feed duct 27, 271, 272 and/or at least in one nozzle feed duct 26 and each manifold feed duct 27, 271, 272 issuing into a further manifold duct 41, 42, 43 and each nozzle feed duct 26 into the flow duct 32 of a particular associated injection molding nozzle. The manifold ducts 41, 42, 43, the manifold feed ducts 27, 271, 272 and/or the nozzle feed ducts 26 are dimensioned in a way to balance the manifold duct system.

The nozzle feed ducts 6 may be arrayed in an n×m matrix where n=m or n≠m or n≧3. The manifold ducts 41, 42, 43 may be formed in one plane and configured horizontally. He manifold feed ducts 27, 271, 272, the nozzle feed ducts 26 and the main feed duct 24 may be configured vertically. The main feed duct 24 is arrayed in a manner that none of the nozzle feed ducts 26 shall be situated directly underneath the main feed duct 24.

The manifold duct system 40 may run over at least two planes 401, 402 each of which contains manifold ducts 41, 42, 43, where the manifold ducts 41, 42, 43 of a first plane 401, 402 communicate through manifold feed ducts 27, 271, 272 with the manifold ducts 41, 42, 43 of a further plane 401, 402. Also the manifold ducts 41, 42, 43 are configured within the planes 401, 402 in a manner that no manifold duct 41, 42, 43 of one plane 401, 402 runs above and/or underneath the manifold duct 41, 42, 43 of another plane 401, 402. The spacings L between the nozzle feed ducts 26 and the manifold feed ducts 27, 271, 272 feeding the manifold ducts 43 issuing into the nozzle fee ducts 26 are always equal.

The manifold plate 201 may comprise a base plate 21, an intermediate plate 22 and a cover plate 23, each manifold duct 41, 42, 43 being bounded by two plates 21, 22, 23 of the manifold 20. The manifold feed ducts 27, 271, 272 are structured in the intermediate plate 22, the nozzle feed ducts 26 in the base plate 21 and/or in the intermediate plate 22 and the main feed duct 24 in the cover plate and/or in the intermediate plate 22.

Be it borne in mind that the main feed duct 24 issues into one or more main manifold ducts 24 and/or that each primary manifold duct 27 issues into one or more lower manifold ducts 242 and/or that each lower manifold duct 42 issues into one or more secondary manifold feed ducts 271, 271 and/or that each secondary manifold feed duct 271, 272 issues into one or more terminal manifold ducts 43 and/or that each terminal manifold duct 43 issues into one or more nozzle feed ducts 26.

In such embodiment modes, the main feed duct 24 may issue into a V-shaped manifold duct constituted by two main manifold ducts 41 and configured in a first plane 401, 402, the V-shaped manifold duct issuing into two primary manifold feed ducts 27. Each primary manifold feed duct 27 issues each time into a lower manifold duct 42, the lower manifold ducts 42 being configured in a second plane 401, 402 and issuing in two secondary manifold feed ducts 271, 272. One secondary manifold feed duct 272 is configured proximally to the main feed duct 24 and another secondary manifold feed duct 271 is configured distally to the main feed duct 24 for each lower manifold duct 42. The secondary manifold feed ducts 27 situated distally from the main feed duct 24 each time feed four terminal manifold ducts 43 and the secondary manifold feed ducts 272 situated proximally to the main feed duct 24 feed each time three terminal manifold ducts 43. The terminal manifold ducts 43 are situated in the first plane 401, 402.

### LIST OF REFERENCE SYMBOLS

| A | spacer |
|---|---|
| B | affixation element |
| D1-D9 | diameter (each) |
| L | spacing |
| M | axis of symmetry |
| P | central point |
| S | securing plate |
| 10 | hot or cold runner |
| 20 | manifold |
| 201 | manifold plate |
| 21 | base plate |
| 212 | recess |
| 211 | Top side of base plate |
| 22 | intermediate plate |
| 221 | intermediate plate's top side |
| 222 | base plate's lower side |
| 23 | cover plate |
| 231 | cover plate's lower side |
| 24 | main feed duct |
| 25 | connection/hookup element |
| 26 | nozzle feed duct |
| 261 | corner-side nozzle feed duct |
| 262 | side-central nozzle feed duct |
| 263 | corner-side nozzle feed duct |
| 264 | side-central nozzle feed duct |
| 265 | central nozzle feed duct |
| 266 | side-central nozzle feed duct |
| 267 | corner-side nozzle feed duct |
| 268 | side-central nozzle feed duct |
| 269 | corner-side nozzle feed duct |
| 27 | manifold feed duct |
| 271 | secondary manifold feed duct |
| 272 | secondary manifold feed duct |
| 30 | material feed pipe |
| 311 | top end |
| 312 | middle segment |
| 313 | lower segment |
| 314 | offset |
| 32 | flow duct |
| 33 | heater |
| 34 | muff |
| 341 | flange |
| 35 | air gap |
| 36 | connection/hookup |
| 361 | conduit |
| 37 | hookup duct |
| 371 | hookup main duct |
| 372 | connecting duct |
| 373 | hookup side duct |
| 374 | hookup main duct |
| 40 | manifold duct system |
| 41 | main manifold duct |
| 411 | tip |
| 42 | lower manifold duct |
| 421 | segment |
| 422 | segment |
| 43 | Terminal manifold duct |
| 431 | ″ |
| 4311 | ″ |
| 4312 | ″ |
| 432 | ″ |
| 433 | ″ |
| 434 | ″ |
| 435 | ″ |
| 436 | ″ |
| 401 | upper plane |
| 402 | lower plane |
| 403 | main arm |
| 404 | main arm |

1. A manifold (20) for a hot or cold runner (10), fitted with a manifold plate (201) which comprises a first main feed duct (24) for a flowable feed material and which contains a manifold duct system (40) with manifold ducts (41, 42, 43), said system communicating flow-wise through nozzle feed ducts (26) with flow ducts (32) of injection molding nozzles (30) connected to the manifold plate (201),
characterized in that
Manifold feed ducts (27, 271, 272) are constituted inside the manifold plate (201),
Each manifold duct (41, 42, 43) communicates flow-wise with the main feed duct (24) or with a manifold feed duct (27, 271, 272),
Each manifold duct (41, 42, 43) issues into at least one manifold feed duct (27, 271, 272) and/or into at least one nozzle feed duct (26), and
Each manifold feed duct (27, 271, 272) issues into a further manifold duct (41, 42, 43) and each nozzle feed duct (26) issues into the flow duct (32) of an associated injection molding nozzle (30), and
in that the manifold ducts (41, 42, 43), the manifold feed ducts (27, 271, 272) and/or the nozzle feed ducts (26) are dimensioned in a way to balance the manifold duct system (40).

2. Manifold (20) as claimed in claim 1, characterized in that the nozzle feed ducts (26) are arrayed in an n×m matrix, where n=m or n≠m.

3. Manifold (20) as claimed in claim 2, characterized in that n≧3.

4. Manifold (20) as claimed in claim 1, characterized in that all manifold ducts (41, 42, 43) are configured in one plane.

5. Manifold (20) as claimed in claim 1, characterized in that the manifold duct system (40) extends at least across two planes (401, 402).

6. Manifold (20) as claimed in claim 5, characterized in that manifold ducts (41, 42, 43) are formed in each plane (401, 402) said ducts of a first plane being connected through manifold feed ducts (27, 271, 272) to the manifold ducts (41, 42, 43) of a further plane (401, 402).

7. Manifold (20) as claimed in claim 5, characterized in that the manifold ducts (41, 42, 43) inside the planes (401, 402) are configured in a manner that no manifold duct (41, 42, 43) of one plane (401, 402) runs above and/or underneath the manifold duct (41, 42, 43) of another plane (401, 402).

8. Manifold (20) as claimed in claim 1, characterized in that the manifold ducts (41, 42, 43) run horizontally and the manifold feed ducts (27, 271, 272) of the nozzle feed ducts (26) and the main feed duct (24) run vertically.

9. Manifold (20) as claimed in claim 1, characterized in that the main feed duct (24) is situated in a manner that none of the nozzle feed ducts (26) lies directly underneath the main feed duct (24).

10. Manifold (20) as claimed in 9 claim 1, characterized in that the main feed duct (24) is situated outside the manifold's central point (P).

11. Manifold (20) as claimed in claim 1, characterized in that the spacings (L) between the nozzle feed ducts (26) and the manifold feed ducts (27, 271, 272), which feed the manifold ducts (43) issuing into the nozzle feed ducts (26), are equal.

12. Manifold (20) as claimed in claim 1, characterized in that the manifold plate (201) comprises a base plate (21), an intermediate plate (22) and a cover plate (23).

13. Manifold (20) as claimed in claim 12, characterized in that each manifold duct (41, 42, 43) is bounded by two plates (21, 22, 23) of the manifold (20).

14. Manifold (20) as claimed in claim 12, characterized in that the manifold feed ducts (27, 271, 272) are constituted in the intermediate plate (22).

15. Manifold (20) as claimed in claim 12, characterized in that the nozzle feed ducts (26) are constituted in the base plate (21) and/or in the intermediate plate (22).

16. Manifold (20) as claimed in claim 12, characterized in that the main feed duct (14) is constituted in the cover plate (23) and/or in the intermediate plate (23).

17. Manifold (20) as claimed in claim 1, characterized in that
The main feed duct (24) issues into one or several main manifold ducts (41) and/or
The main manifold ducts (41) issue into one or several primary manifold feed ducts (27) and/or
Each primary manifold feed duct (27) issues into one or several lower manifold ducts (42) and/or
Each lower manifold duct (42) issues into one or several secondary manifold feed ducts (271, 272) and/or
Each secondary manifold feed duct (271, 272( issue into one or several terminal manifold ducts (43) and/or
Each terminal manifold duct (43) issues into one or several nozzle feed ducts (26).

18. Manifold (20) as claimed in claim 17, characterized in that the main feed duct (24) issues into a V-shaped manifold duct constituted by two main manifold ducts (41) and configured in a first plane (401, 402).

19. Manifold (20) as claimed in claim 18, characterized in that the V-shaped manifold duct issues into two primary manifold feed ducts (27).

20. Manifold (20) as claimed in claim 17, characterized in that each primary manifold feed duct (27) issues into a particular lower manifold duct (42), the lower manifold ducts (42) being situated in a second plane (401, 402) and each issuing into two secondary manifold feed ducts (271, 272).

21. Manifold (20) as claimed in claim 17, characterized in that a secondary manifold feed duct (272) is situated proximally to the main feed duct (24) for each lower manifold feed duct (42) and another secondary manifold feed duct (271) is configured distally from the main feed duct (24).

22. Manifold (20) as claimed in claim 21, characterized in that the secondary manifold feed ducts (271) situated distally from the main feed duct (24) each feed four terminal manifold ducts (43) and that the secondary manifold feed ducts (272) situated proximally to the main feed duct (24) each feed three terminal manifold ducts (43).

23. Manifold (20) as claimed in claim 17, characterized in that the terminal manifold ducts (43) are configured in the first plane (401, 402).

24. Manifold (20) as claimed in claim 1, characterized in that the manifold (20) is a lower manifold.

25. Manifold (20) as claimed in claim 1, characterized in that the manifold (20) is a main manifold and that each nozzle aperture (26) issues into the feed aperture of a lower manifold.

26. Manifold (20) as claimed in claim 12, characterized in that the manifold (20) is fitted with at least two intermediate plates (22).

27. A hot or cold runner (10) comprising a manifold (20) as claimed in claim 1.
